(19) United States
(12) Patent Application Publication
(10) Pub. No.: US 2025/0332966 A1
(43) Pub. Date: Oct. 30, 2025

(54) VEHICLE SEAT FRAME

(71) Applicant: NHK SPRING CO., LTD., Yokohama-shi, Kanagawa (JP)

(72) Inventors: Atsuo MATSUMOTO, Yokohama-shi (JP); Yuma TERADA, Yokohama-shi, Kanagawa (JP)

(21) Appl. No.: 19/186,340

(22) Filed: Apr. 22, 2025

(30) Foreign Application Priority Data
Apr. 25, 2024 (JP) 2024-071713

(51) Int. Cl. B60N 2/20

(52) U.S. Cl. CPC B60N 2/20

(57) ABSTRACT

In a vehicle seat frame, a lower end of a back frame is rotatably coupled to a rear portion of a cushion frame about a rotation center axis having an axial direction in a seat left-right direction. A recliner is fixed to the cushion frame at a seat rear side with respect to the rotation center axis. A rotary link coupled to the cushion frame via the recliner is rotatable about an axis of the recliner with respect to the cushion frame in a state in which the recliner is unlocked. The rotary link with the back frame are coupled by a coupling portion slidably along a height direction of the seat back and rotatably about an axis along the seat left-right direction.

### CROSS-REFERENCE TO RELATED APPLICATION

This application is based on and claims priority under 35 USC 119 from Japanese Patent Application No. 2024-071713 filed on Apr. 25, 2024, the disclosure of which is incorporated by reference herein.

### BACKGROUND

### Technical Field

The present disclosure relates to a vehicle seat frame.

### Related Art

In a vehicle seat device disclosed in Japanese Patent Application Laid-Open (JP-A) No. 2008-149858, an arc portion centered on an assumed rotation center point set based on a hip point of a seated person is formed in a lower portion of the seat back frame. A pin provided on the seat back frame is accommodated in a elongated hole of the arc portion. Since the seat back is inclined rearward while rotating about the assumed rotation center point, a deviation in a relative position between the seated person and the seat back due to an increase in the inclination angle of the seat back is reduced, and a comfortable seating posture can be taken.

### SUMMARY

However, in the above-described related art, since the seat back frame slides along the elongated hole formed in a seat cushion frame, when the seat back frame is reclined, the seat back enters a seat cushion side. As a result, since a relative position of a headrest with respect to the head of the seated person changes, there is room for improvement from the viewpoint of improving comfort of the seated person.

An object of the present disclosure is to provide a vehicle seat frame that can improve comfort of a seated person.

A vehicle seat frame according to a first aspect of the present disclosure includes a cushion frame configuring a framework of a seat cushion, a back frame configuring a framework of a seat back and having a lower end rotatably coupled to a rear portion of the cushion frame about a rotation center axis having an axial direction in left-right direction of a seat, a recliner fixed to the cushion frame at a seat rear side with respect to the rotation center axis and disposed with the seat left-right direction as an axial direction, a rotary link coupled to the cushion frame via the recliner and rotatable about an axis of the recliner with respect to the cushion frame in a state in which the recliner is unlocked, and a coupling portion coupling the rotary link with the back frame slidably along a height direction of the seat back and rotatably about an axis along the seat left-right direction.

In the vehicle seat frame according to the first aspect, a lower end of the back frame configuring the framework of the seat back is coupled to a rear portion of the cushion frame configuring the framework of the seat cushion rotatably about the rotation center axis having an axial direction in the seat left-right direction. A recliner disposed with the seat left-right direction as an axial direction is fixed to the cushion frame at a seat rear side with respect to the rotation center axis. A rotary link coupled to the cushion frame via the recliner is rotatable about an axis of the recliner with respect to the cushion frame in a state in which the recliner is unlocked. The rotary link with the back frame are coupled by a coupling portion slidably along a height direction of the seat back and rotatably about an axis along the seat left-right direction.

In this vehicle seat frame, when the recliner is unlocked, the back frame rotates about the rotation center axis with respect to the cushion frame, the rotary link rotates about the axis of the recliner, and a change in the relative position between the rotary link with the back frame is absorbed by the coupling portion. By arranging the above rotation center axis and the rotation center position of the seated person at the time of rotation of the back frame close to each other, it is possible to suppress a phenomenon (so-called back deviation) in which the back of the seated person is shifted in the height direction of the seat back with respect to the seat back. Moreover, since the seat back does not enter the seat cushion side during reclining as in the related art described in the background art, it is possible to prevent a relative position between the headrest provided at the upper end of the seat back and the head of the seated person from changing. Therefore, comfort of the seated person can be improved.

In a vehicle seat frame according to a second aspect, in the first aspect, the coupling portion includes an elongated hole formed in the back frame and a sliding pin fixed to the rotary link and inserted into the elongated hole.

In the vehicle seat frame according to the second aspect, when the back frame rotates about the rotation center axis with respect to the cushion frame and the rotary link rotates about the axis of the recliner, the sliding pin fixed to the rotary link slides in the elongated hole formed in the back frame. Thus, a change in the relative position between the rotary link with the back frame can be absorbed with a simple configuration.

In a vehicle seat frame according to a third aspect, in the first aspect or the second aspect, the cushion frame includes a cushion side frame disposed on a side portion of the seat cushion, and a locking portion that is provided at a rear end of the cushion side frame and configured to lock a bracket to which the recliner is fixed.

In the vehicle seat frame according to the third aspect, a locking portion for the bracket is provided at a rear end of a cushion side frame disposed on a side portion of the seat cushion, and the recliner is fixed to the bracket. The rotary link is coupled to the bracket via the recliner. With such a configuration, the bracket, the recliner, and the rotary link can be assembled.

As described above, according to the present disclosure, it is possible to improve the comfort of the seated person.

### BRIEF DESCRIPTION OF THE DRAWINGS

Exemplary embodiments of the present invention will be described in detail based on the following figures, wherein:

FIG. 1 is a side view illustrating a vehicle seat frame according to an embodiment;

FIG. 2 is a side view corresponding to FIG. 1 and illustrating a state in which a back frame is located at a foremost end position;

FIG. 3 is a side view corresponding to FIG. 1 and illustrating a state in which the back frame is located at a rearmost end position;

FIG. 4 is a side view illustrating a part of FIG. 1 in an enlarged manner;

and

FIG. 5 is a schematic rear view illustrating a configuration illustrated in FIG. 4 as viewed from a seat rear side.

### DETAILED DESCRIPTION

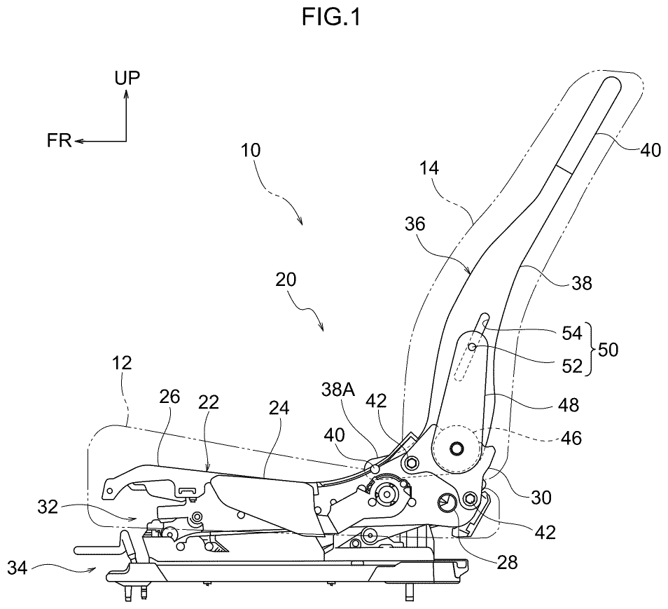

Hereinafter, a vehicle seat frame 20 according to an embodiment of the present disclosure will be described with reference to FIGS. 1 to 5. Arrows FR, LH, and UP appropriately illustrated in the drawings indicate a front side, a left side, and an upper side of a vehicle seat 10 including the vehicle seat frame 20, respectively. Hereinafter, when simply described using the front, rear, left, right, and up and down directions, directions with respect to the vehicle seat 10 are indicated.

As illustrated in FIG. 1, the vehicle seat frame 20 according to the present embodiment forms a framework of the vehicle seat 10. As illustrated in FIGS. 1 to 3, the vehicle seat frame 20 includes a cushion frame 22 configuring a framework of a seat cushion 12 and a back frame 36 configuring a framework of a seat back 14.

The cushion frame 22 includes two left and right cushion side frames 24 (the right cushion side frame 24 is not illustrated) arranged on the left and right sides of the seat cushion 12, a front frame 26 connecting front ends of the left and right cushion side frames 24 in the left-right direction, and a rear frame 28 connecting rear ends of the left and right cushion side frames 24 in the left-right direction. At rear ends of the left and right cushion side frames 24, locking portions (reference signs omitted) for locking the two left and right brackets 30 are provided.

The left and right cushion side frames 24, the front frame 26, and the left and right brackets 30 are formed by, for example, press-molded metal plate members, and the rear frame 28 is formed by, for example, metal pipe members. The above cushion frame 22 is coupled to a floor portion (not illustrated) of the vehicle body via a known lifter mechanism 32 and a known seat slide mechanism 34.

The back frame 36 includes two left and right back side frames 38 (the right back side frame 38 is not illustrated) arranged on the left and right sides of the seat back 14, an upper frame 40 connecting upper ends of the left and right back side frames 38 in the left-right direction, and a lower frame (not illustrated) connecting lower ends of the left and right back side frames 38 in the left-right direction.

The left and right back side frames 38 and the lower frame are formed by, for example, press-molded metal plate members, and the upper frame 40 is formed by, for example, metal pipe members. A stay of a headrest (not illustrated) is coupled to the upper frame 40.

Front extending portions 38A extending toward the front side of the seat back 14 are provided at lower ends of the left and right back side frames 38. Front ends of the left and right front extending portions 38A are coupled to rear portions of the left and right cushion side frames 24 via two left and right rotation center axes 40 (the right rotation center axis 40 is not illustrated). The left and right rotation center axes 40 has an axial direction that is the left-right direction, and are disposed coaxially with each other.

The back frame 36 in which the lower ends of the left and right back side frames 38 are coupled to the rear portions of the left and right cushion side frames 24 via the left and right rotation center axes 40 is rotatable about the left and right rotation center axes 40 (that is, about the axis along the left-right direction) with respect to the cushion frame 22.

The left and right brackets 30 are disposed on the rear side of the left and right rotation center axes 40. Each bracket 30 is locked (fastened and fixed) to the rear end of each cushion side frame 24 using two front and rear bolts 42 and two front and rear nuts (not illustrated). A known recliner (reclining unit) 46 is fixed to the bracket 30 on one side in the left-right direction (here, the left side).

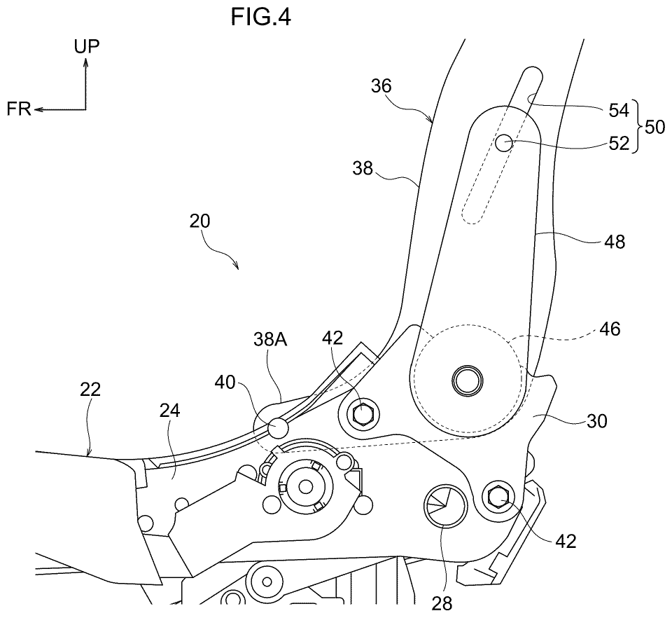

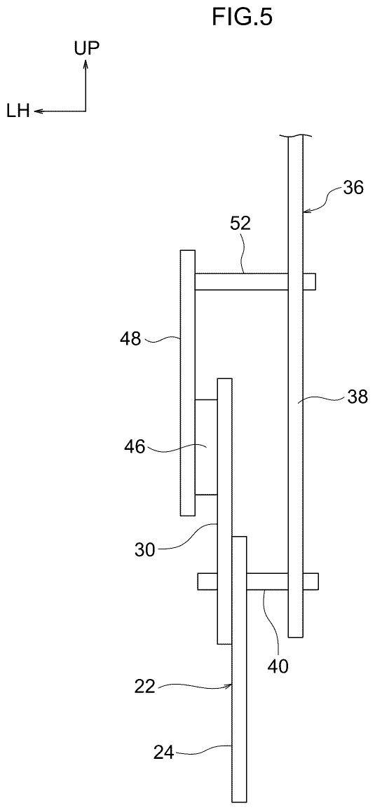

As illustrated in FIGS. 4 and 5, the recliner 46 has a disk shape whose axial direction is the left-right direction, and is disposed on one side in the left-right direction (here, an outside in the left-right direction) with respect to the bracket 30 disposed on the outside in the left-right direction of the cushion frame 22. The recliner 46 is fixed to the left bracket 30 by welding or the like. A rotary link 48 is disposed on a side opposite to the bracket 30 disposed on the outside in the above left-right direction via the recliner 46.

The rotary link 48 is formed by, for example, a metal plate, and has a long plate shape in which a height direction of the seat back 14 is a longitudinal direction and a left-right direction is a plate thickness direction. The rotary link 48 is disposed on one side in the left-right direction (here, the outside in the left-right direction) with respect to the recliner 46. One end of the rotary link 48 in the longitudinal direction is fixed to the recliner 46 by welding or the like.

A sliding pin 52 is fixed to another end of the rotary link 48 in the longitudinal direction. The sliding pin 52 is formed by, for example, a metal round bar, and has a columnar shape with the left-right direction as the axial direction. One end of the sliding pin 52 is fixed to the other end of the rotary link 48 in the longitudinal direction by means of welding or the like. The sliding pin 52 protrudes from the other end of the rotary link 48 in the longitudinal direction toward the back frame 36 (right side in this case).

An elongated hole 54 is formed in the left back side frame 38 corresponding to the above sliding pin 52. In the elongated hole 54, the height direction of the seat back 14 is the longitudinal direction, and penetrates the left back side frame 38 in the left-right direction. The other end of the sliding pin 52 is inserted into the elongated hole 54. Thus, the rotary link 48 and the back frame 36 are coupled to each other so as to be slidable along the height direction of the seat back 14 and to be rotatable about the axis along the left-right direction. The above elongated hole 54 constitutes a coupling portion 50 together with the sliding pin 52.

In the vehicle seat frame 20 having the above configuration, when the unlocking lever (not illustrated) coupled to the recliner 46 is not operated, the recliner 46 is locked, and the rotary link 48 is restricted from rotating relative to the cushion frame 22. In this state, the back frame 36 in which the sliding pin 52 of the rotary link 48 is inserted into the elongated hole 54 of the back side frame 38 is restricted from rotating about the rotation center axis 40 with respect to the cushion frame 22.

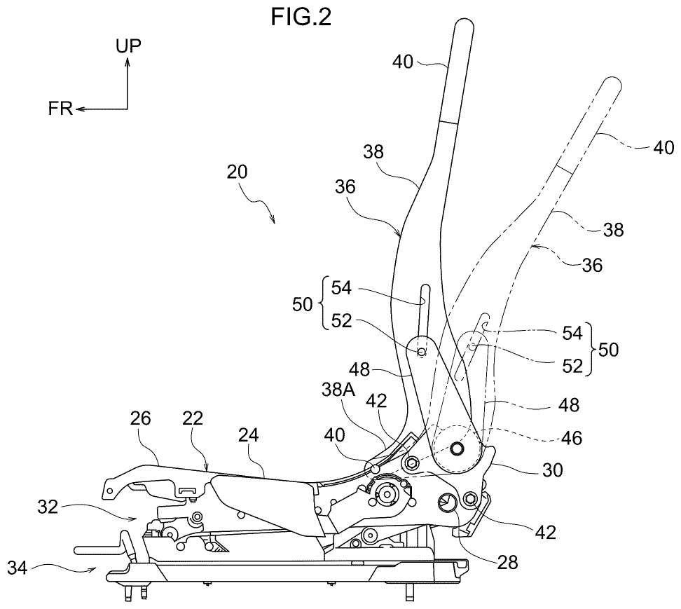

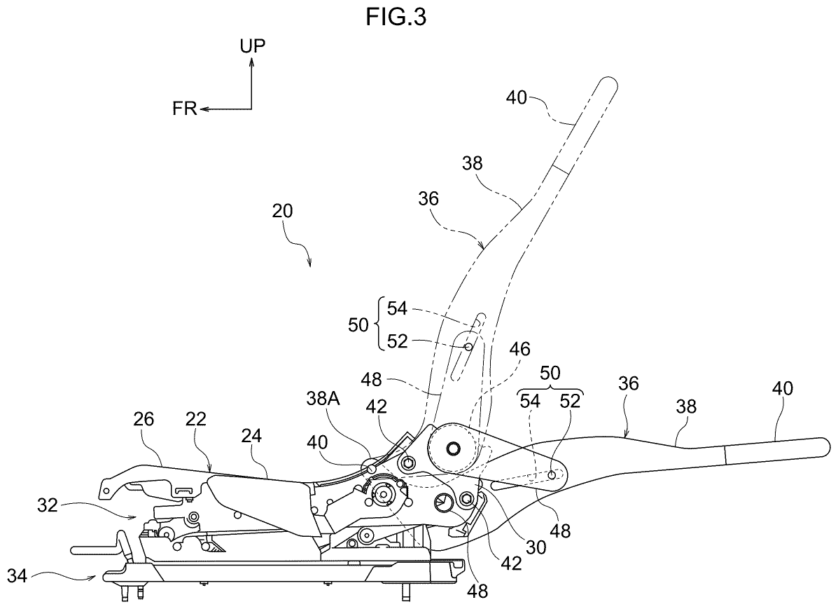

In a state in which the above unlocking lever is operated and the recliner 46 is unlocked, the rotary link 48 is rotatable about the axis of the recliner 46 with respect to the cushion frame 22. In this state, the back frame 36 in which the sliding pin 52 of the rotary link 48 is inserted into the elongated hole 54 of the back side frame 38 is allowed to rotate (tilt) about the rotation center axis 40 with respect to the cushion frame 22. In this state, the back frame 36 is rotatable between a front end position indicated by a solid line in FIG. 2 and a rear end position indicated by a solid line in FIG. 3.

The above rotation center axis 40 and a rotation center position of the seated person during the rotation of the back frame 36 are disposed close to each other. When the back frame 36 rotates about the rotation center axis 40 with respect to the cushion frame 22, the sliding pin 52 slides in the elongated hole 54 along the longitudinal direction of the elongated hole 54. Thus, a change in the relative position between the rotary link 48 and the back frame 36 is absorbed.

Next, functions and effects of the present embodiment will be described.

In the vehicle seat frame 20 according to the present embodiment, a lower end of the back frame 36 configuring the framework of the seat back 14 is coupled to the rear portion of the cushion frame 22 configuring the framework of the seat cushion so as to be rotatable about the rotation center axis 40 whose axial direction is the left-right direction. The recliner 46 disposed with the left-right direction as the axial direction is fixed to the cushion frame 22 on the rear side of the rotation center axis 40. The rotary link 48 coupled to the cushion frame 22 via the recliner 46 is rotatable about the axis of the recliner 46 with respect to the cushion frame 22 in a state in which the recliner 46 is unlocked. The rotary link 48 and the back frame 36 are coupled by the coupling portion 50 so as to be slidable along the height direction of the seat back 14 and rotatable about the axis along the left-right direction.

In this vehicle seat frame, when the recliner 46 is unlocked, the back frame 36 rotates about the rotation center axis with respect to the cushion frame 22, the rotary link 48 rotates about the axis of the recliner 46, and a change in the relative position between the rotary link 48 and the back frame 36 is absorbed by the coupling portion 50. Since the above rotation center axis 40 and the rotation center position of the seated person at the time of rotation of the back frame 36 are arranged close to each other, it is possible to suppress a phenomenon (so-called back misalignment) in which the back of the seated person is shifted in the height direction of the seat back 14 with respect to the seat back 14. Moreover, since the seat back does not enter the seat cushion side during reclining as in the related art described in the background art, it is possible to prevent a relative position between a headrest (not illustrated) provided at the upper end of the seat back 14 and the head of the seated person from changing. Therefore, comfort of the seated person can be improved.

Furthermore, since an existing recliner can be used as the above-described recliner 46, it is possible to ensure sufficient lock strength with a simple structure while maintaining the operability of unlocking. In the related art described in the background art, it is necessary to provide a stretchable intermediate pad between the cushion pad and the back pad. However, in the present embodiment, since the rotation center axis 40 of the back frame 36 can be disposed near the surface of the seat cushion 12, the intermediate pad as described above is unnecessary.

In the vehicle seat frame 20, when the back frame 36 rotates about the rotation center axis 40 with respect to the cushion frame 22 and the rotary link 48 rotates about the axis of the recliner 46, the sliding pin 52 fixed to the rotary link 48 slides in the elongated hole 54 formed in the back frame 36. Thus, a change in the relative position between the rotary link 48 and the back frame 36 can be absorbed with a simple configuration.

In the vehicle seat frame 20, a locking portion of the bracket 30 is provided at a rear end of the cushion side frame 24 disposed on a side portion of the seat cushion 12, and the recliner 46 is fixed to the bracket 30. The rotary link 48 is coupled to the bracket 30 via the recliner 46. With such a configuration, the bracket 30, the recliner 46, and the rotary link 48 can be assembled into a subassembly, which contributes to facilitation of manufacturing of the vehicle seat frame 20.

The above embodiment is configured such that the recliner 46 is fixed to the bracket 30 fixed to the rear end of the left cushion side frame 24, but is not limited to this configuration. The recliner 46 may be directly fixed to the rear end of the cushion side frame 24.

The above embodiment may be configured such that the bracket 30, the recliner 46, and the rotary link 48 are disposed on the left side of the vehicle seat frame 20, but the embodiment is not limited to this configuration, and the bracket, the recliner, and the rotary link may be disposed on the right side of the vehicle seat frame 20.

In the above embodiment, the case where the coupling portion 50 is formed by the sliding pin 52 and the elongated hole 54 has been described, but the embodiment is not limited thereto. The coupling portion may be any one that couples the rotary link 48 and the back frame 36 slidably along the height direction of the seat back 14 and rotatably around an axis along the left-right direction.

In addition, the present disclosure can be variously modified without departing from the gist thereof. It is a matter of course that the scope of rights of the present disclosure is not limited to the above embodiments.

What is claimed is:

1. A vehicle seat frame, comprising:
a cushion frame configuring a framework of a seat cushion;
a back frame configuring a framework of a seat back and having a lower end rotatably coupled to a rear portion of the cushion frame about a rotation center axis having an axial direction in left-right direction of a seat;
a recliner fixed to the cushion frame at a seat rear side with respect to the rotation center axis and disposed with the seat left-right direction as an axial direction;
a rotary link coupled to the cushion frame via the recliner and rotatable about an axis of the recliner with respect to the cushion frame in a state in which the recliner is unlocked; and
a coupling portion coupling the rotary link with the back frame slidably along a height direction of the seat back and rotatably about an axis along the seat left-right direction.

2. The vehicle seat frame according to claim 1, wherein the coupling portion includes:
an elongated hole formed in the back frame; and
a sliding pin fixed to the rotary link and inserted into the elongated hole.

3. The vehicle seat frame according to claim 1, wherein the cushion frame includes:
a cushion side frame disposed on a side portion of the seat cushion; and
a locking portion that is provided at a rear end of the cushion side frame and configured to lock a bracket to which the recliner is fixed.
